(19) United States
(12) Patent Application Publication
(10) Pub. No.: US 2014/0174069 A1
(43) Pub. Date: Jun. 26, 2014

(54) HYDRAULIC CONTROL SYSTEM HAVING SWING MOTOR ENERGY RECOVERY

(71) Applicants: Jeffrey L. Kuehn, Germantown Hills, IL (US); Jeremy T. Peterson, Washington, IL (US); Gang Wen, Dunlap, IL (US)

(72) Inventors: Jeffrey L. Kuehn, Germantown Hills, IL (US); Jeremy T. Peterson, Washington, IL (US); Gang Wen, Dunlap, IL (US)

(73) Assignee: Caterpillar Inc., Peoria, IL (US)

(21) Appl. No.: 13/723,796

(22) Filed: Dec. 21, 2012

(51) Int. Cl. F15B 1/033; F15B 21/14; F15B 13/02

(52) U.S. Cl. CPC F15B 1/033; F15B 13/022; F15B 21/14
USPC 60/414; 60/459; 91/361

(57) ABSTRACT

A hydraulic control system for a machine is disclosed. The hydraulic control system may have a tank, a pump, a swing motor having a first chamber and a second chamber, and at least one control valve configured to control fluid flow between the pump, the swing motor, and the tank. The hydraulic system may also have an accumulator configured to selectively receive pressurized fluid discharged from the swing motor and selectively supply pressurized fluid to the swing motor and a controller. The hydraulic control system may further include a first valve and a second valve coupled between the accumulator and the first and the second chambers of the swing motor. One of the first or second valve moves between a first position, a second position, and a third position for selective charging and discharging of the accumulator. The second valve also moves between multiple positions to realize selective charging and discharging of the accumulator.

### TECHNICAL FIELD

The present disclosure relates generally to a hydraulic control system and, more particularly, to a hydraulic control system having swing energy recovery.

### BACKGROUND

Swing-type excavation machines, for example hydraulic excavators and front shovels, require significant hydraulic pressure and flow to transfer material from a dig location to a dump location. These machines direct the high-pressure fluid from an engine-driven pump through a swing motor to accelerate a loaded work tool at the start of each swing, and then restrict the flow of fluid exiting the motor at the end of each swing to slow and stop the work tool.

One problem associated with this type of hydraulic arrangement involves efficiency. In particular, the fluid exiting the swing motor at the end of each swing is under a relatively high pressure due to deceleration of the loaded work tool. Unless recovered, energy associated with the high-pressure fluid may be wasted. In addition, restriction of this high-pressure fluid exiting the swing motor at the end of each swing can result in heating of the fluid, which must be accommodated with an increased cooling capacity of the machine.

One attempt to improve the efficiency of a swing-type machine is disclosed in U.S. Pat. No. 7,908,852 of Zhang et al. that issued on Mar. 22, 2011 (the '852 patent). The '852 patent discloses a hydraulic control system for a machine that includes an accumulator. The accumulator stores exit oil from a swing motor that has been pressurized by inertia torque applied on the moving swing motor by an upper structure of the machine. The pressurized oil in the accumulator is then selectively reused to accelerate the swing motor during a subsequent swing by supplying the accumulated oil back to the swing motor.

Although the hydraulic control system of the '852 patent may help to improve efficiencies of a swing-type machine in some situations, it may still be less than optimal. In particular, during discharge of the accumulator described in the '852 patent, some pressurized fluid exiting the swing motor may still have useful energy that is wasted. In addition, there may be situations during operation of the hydraulic control system of the '852 patent, for example during deceleration and accumulator charging, when a pump output is unable to supply fluid at a rate sufficient to prevent cavitation in the swing motor. Further, the machine may operate differently under different conditions and in different situations, and the hydraulic control system of the '852 patent may not be configured to adapt control to these different conditions and situations. Also, the '852 patent describes the use of a pressure-controlled selector valve to ensure that the accumulator is connected to the appropriate side of the swing motor. Finally, the '852 patent does not disclose a way to transition between normal and accumulator swing modes of operation.

The disclosed hydraulic control system is directed to overcoming one or more of the problems set forth above and/or other problems of the prior art.

### SUMMARY

One aspect of the present disclosure is directed to a hydraulic control system. The hydraulic control system may include a tank; a pump configured to draw fluid from the tank and pressurize the fluid; a swing motor, having a first chamber and a second chamber, wherein the swing motor is driven by a flow of pressurized fluid from the pump; port pressure sensors associated with each of the first and second chamber of the swing motor; an accumulator configured to selectively receive pressurized fluid discharged from the swing motor and selectively supply pressurized fluid to the swing motor; an accumulator pressure sensor associated with the accumulator; a first valve is coupled between the accumulator and the first and second chambers of the swing motor, and a second valve is coupled between the accumulator and the first and second chambers of the swing motor. At least one of the first and second valves is a three-way valve movable between a first position, a second position, and a third position, at the first position flow of the fluid between the swing motor and the accumulator is inhibited, at the second position one of the first and second chambers of the swing motor is fluidly coupled to the accumulator and the other of the first and second chambers of the swing motor is blocked from fluid communication with the accumulator, at the third position the other of the first and second chambers of the swing motor is fluidly coupled to the accumulator and the one of the first and second chambers of the swing motor is blocked from fluid communication with the accumulator. The hydraulic system further includes a controller in electrical communication with the first valve and the second valve and the port and accumulator pressure sensors; the controller configured to command movement of at least one of the first valve and the second valve based on the pressure of the chambers and the accumulator.

In another aspect of the present disclosure, the hydraulic control system includes a tank a pump configured to draw fluid from the tank and pressurize the fluid; a swing motor, having a first chamber and a second chamber, wherein the swing motor is driven by a flow of pressurized fluid from the pump; a means for sensing pressure of each of the first and second chambers of the swing motor; an accumulator configured to selectively receive pressurized fluid discharged from the swing motor and selectively supply pressurized fluid to the swing motor; a means for sensing an accumulator pressure; a first valve coupled between the accumulator and the first and second chambers of the swing motor, and a second valve coupled between the accumulator and the first valve. At least one of the first and second valves is a three-way valve movable between a first position, a second position, and a third position, at the first position flow of the fluid between the swing motor and the accumulator is inhibited, at the second position one of the first and second chambers of the swing motor is fluidly coupled to the accumulator and the other of the first and second chambers of the swing motor is fluidly coupled to the second valve, at the third position the other of the first and second chambers of the swing motor is fluidly coupled to the accumulator and the one of the first and second chambers of the swing motor is fluidly coupled to the second valve. The hydraulic system further includes a controller in electrical communication with the first valve and the second valve and the means for sensing pressure of the chambers and the means for sensing accumulator pressure; the controller configured to command movement of at least one of the first valve and the second valve based on the pressure of the chambers and the accumulator.

In yet another aspect of the present disclosure, the hydraulic control system includes a tank; a pump configured to draw fluid from the tank and pressurize the fluid; a swing motor, having a first chamber and a second chamber, wherein the swing motor is driven by a flow of pressurized fluid from the pump; port pressure sensors associated with each of the first and second chambers of the swing motor; an accumulator configured to selectively receive pressurized fluid discharged from the swing motor and selectively supply pressurized fluid to the swing motor; an accumulator pressure sensor associated with the accumulator; a first check valve coupled between the accumulator and the first chamber of the swing motor, and a second check valve coupled between the accumulator and the second chamber of the swing motor; a first valve coupled between the accumulator and the first and second chambers of the swing motor, and a second valve coupled between the accumulator and the first and second check valves. The first valve is a three-way valve movable between a first position, a second position, and a third position, at the first position flow of the fluid between the swing motor and the accumulator is inhibited, at the second position one of the first and second chambers of the swing motor is fluidly coupled to the accumulator and the other of the first and second chambers of the swing motor is blocked from fluid communication with the accumulator, at the third position the other of the first and second chambers of the swing motor is fluidly coupled to the accumulator and the one of the first and second chambers of the swing motor is blocked from fluid communication with the accumulator. The second valve is a two-way valve movable between a first position and a second position, at the first position flow of the fluid between the swing motor and the accumulator is inhibited, at the second position a higher pressure one of the first and second chambers of the swing motor is fluidly coupled to the accumulator. The hydraulic system further includes a controller in electrical communication with the first valve and the second valve and the port and accumulator pressure sensors; the controller configured to command movement of at least one of the first valve and the second valve based on the pressure of the chambers and the accumulator.

### BRIEF DESCRIPTION OF THE DRAWINGS

FIG. 1 is a diagrammatic illustration of an exemplary disclosed machine operating at a worksite with a haul vehicle;

FIG. 2 is a schematic illustration of an exemplary disclosed hydraulic control system that may be used with the machine of FIG. 1;

FIG. 3 is a schematic illustration of an alternate configuration of the exemplary disclosed hydraulic control system that may be used with the machine of FIG. 1;

FIG. 4 is a schematic illustration of another alternate configuration of the exemplary disclosed hydraulic control system that may be used with the machine of FIG. 1;

FIG. 5 is an exemplary disclosed control map that may be used by the hydraulic control system; and

FIG. 6 is a flowchart depicting an exemplary disclosed method that may be performed by the hydraulic control system.

### DETAILED DESCRIPTION

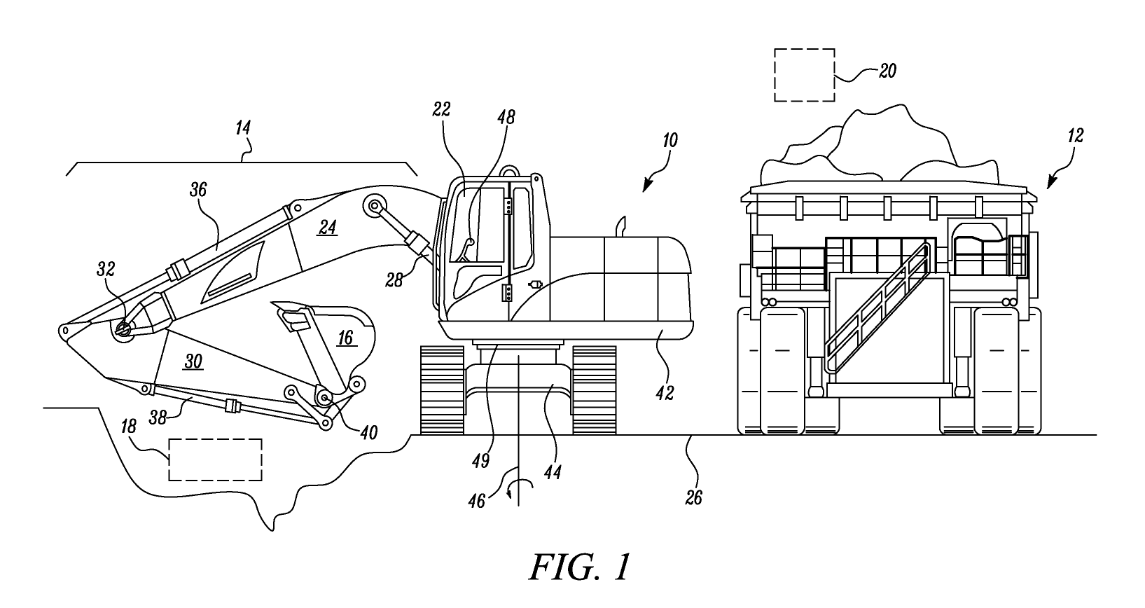

FIG. 1 illustrates an exemplary machine 10 having multiple systems and components that cooperate to excavate and load earthen material onto a nearby haul vehicle 12. In the depicted example, machine 10 is a hydraulic excavator. It is contemplated, however, that machine 10 could alternatively embody another swing-type excavation or material handling machine, such as a backhoe, a front shovel, a dragline excavator, or another similar machine. Machine 10 may include, among other things, an implement system 14 configured to move a work tool 16 between a dig location 18 within a trench or at a pile, and a dump location 20, for example over haul vehicle 12. Machine 10 may also include an operator station 22 for manual control of implement system 14. It is contemplated that machine 10 may perform operations other than truck loading, if desired, such as craning, trenching, and material handling.

Implement system 14 may include a linkage structure acted on by fluid actuators to move work tool 16. Specifically, implement system 14 may include a boom 24 that is vertically pivotal relative to a work surface 26 by a pair of adjacent, double-acting, hydraulic cylinders 28 (only one shown in FIG. 1). Implement system 14 may also include a stick 30 that is vertically pivotal about a horizontal pivot axis 32 relative to boom 24 by a single, double-acting, hydraulic cylinder 36. Implement system 14 may further include a single, double-acting, hydraulic cylinder 38 that is operatively connected to work tool 16 to tilt work tool 16 vertically about a horizontal pivot axis 40 relative to stick 30. Boom 24 may be pivotally connected to a frame 42 of machine 10, while frame 42 may be pivotally connected to an undercarriage member 44 and swung about a vertical axis 46 by a swing motor 49. Stick 30 may pivotally connect work tool 16 to boom 24 by way of pivot axes 32 and 40. It is contemplated that a greater or lesser number of fluid actuators may be included within implement system 14 and connected in a manner other than described above, if desired.

Numerous different work tools 16 may be attachable to a single machine 10 and controllable via operator station 22. Work tool 16 may include any device used to perform a particular task such as, for example, a bucket, a fork arrangement, a blade, a shovel, a crusher, a shear, a grapple, a grapple bucket, a magnet, or any other task-performing device known in the art. Although connected in the embodiment of FIG. 1 to lift, swing, and tilt relative to machine 10, work tool 16 may alternatively or additionally rotate, slide, extend, open and close, or move in another manner known in the art.

Operator station 22 may be configured to receive input from a machine operator indicative of a desired work tool movement. Specifically, operator station 22 may include one or more input devices 48 embodied, for example, as single or multi-axis joysticks located proximal an operator seat (not shown). Input devices 48 may be proportional-type controllers configured to position and/or orient work tool 16 by producing a work tool position signal that is indicative of a desired work tool speed and/or force in a particular direction. The position signal may be used to actuate any one or more of hydraulic cylinders 28, 36, 38 and/or swing motor 49. It is contemplated that different input devices may alternatively or additionally be included within operator station 22 such as, for example, wheels, knobs, push-pull devices, switches, pedals, and other operator input devices known in the art.

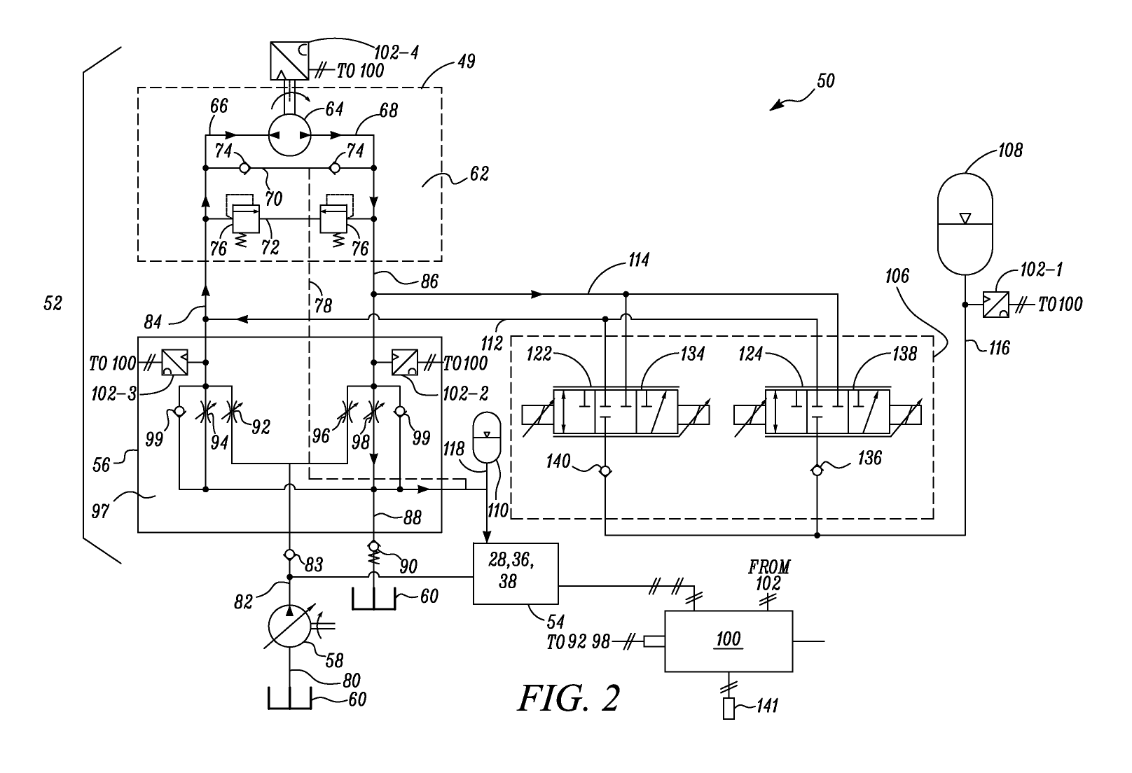

As illustrated in FIG. 2, machine 10 may include a hydraulic control system 50 having a plurality of fluid components that cooperate to move implement system 14 (referring to FIG. 1). In particular, hydraulic control system 50 may include a first circuit 52 associated with swing motor 49, and at least a second circuit 54 associated with hydraulic cylinders 28, 36, and 38. First circuit 52 may include, among other things, a swing control valve 56 connected to regulate a flow of pressurized fluid from a pump 58 to swing motor 49 and from swing motor 49 to a low-pressure tank 60 to cause a swinging movement of work tool 16 about axis 46 (referring to FIG. 1) in accordance with an operator request received via input device 48. Second circuit 54 may include similar control valves, for example a boom control valve (not shown), a stick control valve (not shown), a tool control valve (not shown), a travel control valve (not shown), and/or an auxiliary control valve connected in parallel to receive pressurized fluid from pump 58 and to discharge waste fluid to tank 60, thereby regulating the corresponding actuators (e.g., hydraulic cylinders 28, 36, and 38).

Swing motor 49 may include a housing 62 at least partially forming a first and a second chamber (not shown) located to either side of an impeller 64. When the first chamber is connected to an output of pump 58 (e.g., via a first chamber passage 66 formed within housing 62) and the second chamber is connected to tank 60 (e.g., via a second chamber passage 68 formed within housing 62), impeller 64 may be driven to rotate in a first direction (shown in FIG. 2). Conversely, when the first chamber is connected to tank 60 via first chamber passage 66 and the second chamber is connected to pump 58 via second chamber passage 68, impeller 64 may be driven to rotate in an opposite direction (not shown). The flow rate of fluid through impeller 64 may relate to a rotational speed of swing motor 49, while a pressure differential across impeller 64 may relate to an output torque thereof.

Swing motor 49 may include built-in makeup and relief functionality. In particular, a makeup passage 70 and a relief passage 72 may be formed within housing 62, between first chamber passage 66 and second chamber passage 68. A pair of opposing check valves 74 and a pair of opposing relief valves 76 may be disposed within makeup and relief passages 70, 72, respectively. A low-pressure passage 78 may be connected to each of makeup and relief passages 70, 72 at locations between check valves 74 and between relief valves 76. Based on a pressure differential between low-pressure passage 78 and first and second chamber passages 66, 68, one of check valves 74 may open to allow fluid from low-pressure passage 78 into the lower-pressure one of the first and second chambers. Similarly, based on a pressure differential between first and second chamber passages 66, 68 and low-pressure passage 78, one of relief valves 76 may open to allow fluid from the higher-pressure one of the first and second chambers into low-pressure passage 78. A significant pressure differential may generally exist between the first and second chambers during a swinging movement of implement system 14.

Pump 58 may be configured to draw fluid from tank 60 via an inlet passage 80, pressurize the fluid to a desired level, and discharge the fluid to first and second circuits 52, 54 via a discharge passage 82. A check valve 83 may be disposed within discharge passage 82, if desired, to provide for a unidirectional flow of pressurized fluid from pump 58 into first and second circuits 52, 54. Pump 58 may embody, for example, a variable displacement pump (shown in FIG. 1), a fixed displacement pump, or another source known in the art. Pump 58 may be drivably connected to a power source (not shown) of machine 10 by, for example, a countershaft (not shown), a belt (not shown), an electrical circuit (not shown), or in another suitable manner. Alternatively, pump 58 may be indirectly connected to the power source of machine 10 via a torque converter, a reduction gear box, an electrical circuit, or in any other suitable manner. Pump 58 may produce a stream of pressurized fluid having a pressure level and/or a flow rate determined, at least in part, by demands of the actuators within first and second circuits 52, 54 that correspond with operator requested movements. Discharge passage 82 may be connected within first circuit 52 to first and second chamber passages 66, 68 via swing control valve 56 and first and second chamber conduits 84, 86, respectively, which extend between swing control valve 56 and swing motor 49.

Tank 60 may constitute a reservoir configured to hold a low-pressure supply of fluid. The fluid may include, for example, dedicated hydraulic oil, an engine lubrication oil, a transmission lubrication oil, or any other fluid known in the art. One or more hydraulic systems within machine 10 may draw fluid from and return fluid to tank 60. It is contemplated that hydraulic control system 50 may be connected to multiple separate fluid tanks or to a single tank, as desired. Tank 60 may be fluidly connected to swing control valve 56 via a drain passage 88, and to first and second chamber passages 66, 68 via swing control valve 56 and first and second chamber conduits 84, 86, respectively. A check valve 90 may be disposed within drain passage 88, if desired, to promote a unidirectional flow of fluid into tank 60.

Swing control valve 56 may have elements that are movable to control the rotation of swing motor 49 and corresponding swinging motion of implement system 14. Specifically, swing control valve 56 may include a first chamber supply element 92, a first chamber drain element 94, a second chamber supply element 96, and a second chamber drain element 98 all disposed within a common block or housing. The first and second chamber supply elements 92, 96 may be connected in parallel with discharge passage 82 to regulate filling of their respective chambers with fluid from pump 58, while the first and second chamber drain elements 94, 98 may be connected in parallel with drain passage 88 to regulate draining of the respective chambers of fluid. A makeup valve 99, for example a check valve, may be disposed between an outlet of first chamber drain element 94 and first chamber conduit 84 and between an outlet of second chamber drain element 98 and second chamber conduit 86.

To drive swing motor 49 to rotate in a first direction (shown in FIG. 2), first chamber supply element 92 may be shifted to allow pressurized fluid from pump 58 to enter the first chamber of swing motor 49 via discharge passage 82 and first chamber conduit 84, while second chamber drain element 98 may be shifted to allow fluid from the second chamber of swing motor 49 to drain to tank 60 via second chamber conduit 86 and drain passage 88. To drive swing motor 49 to rotate in the opposite direction, second chamber supply element 96 may be shifted to communicate the second chamber of swing motor 49 with pressurized fluid from pump 58, while first chamber drain element 94 may be shifted to allow draining of fluid from the first chamber of swing motor 49 to tank 60. It is contemplated that both the supply and drain functions of swing control valve 56 (i.e., of the four different supply and drain elements) may alternatively be performed by a single valve element associated with the first chamber and a single valve element associated with the second chamber, or by a single valve element associated with both the first and second chambers, if desired.

Supply and drain elements 92-98 of swing control valve 56 may be solenoid-movable against a spring bias in response to a flow rate and/or position command issued by a controller 100. In particular, swing motor 49 may rotate at a velocity that corresponds with the flow rate of fluid into and out of the first and second chambers. Accordingly, to achieve an operator-desired swing torque, a command based on an assumed or measured pressure drop may be sent to the solenoids (not shown) of supply and drain elements 92-98 that causes them to open an amount corresponding to the necessary fluid pressure at swing motor 49. This command may be in the form of a flow rate command or a valve element position command that is issued by controller 100.

Controller 100 may be in communication with the different components of hydraulic control system 50 to regulate operations of machine 10. For example, controller 100 may be in communication with the elements of swing control valve 56 in first circuit 52 and with the elements of control valves (not shown) associated with second circuit 54. Based on various operator input and monitored parameters, as will be described in more detail below, controller 100 may be configured to selectively activate the different control valves in a coordinated manner to efficiently carry out operator requested movements of implement system 14.

Controller 100 may include a memory, a secondary storage device, a clock, and one or more processors that cooperate to accomplish a task consistent with the present disclosure. Numerous commercially available microprocessors can be configured to perform the functions of controller 100. It should be appreciated that controller 100 could readily embody a general machine controller capable of controlling numerous other functions of machine 10. Various known circuits may be associated with controller 100, including signal-conditioning circuitry, communication circuitry, and other appropriate circuitry. It should also be appreciated that controller 100 may include one or more of an application-specific integrated circuit (ASIC), a field-programmable gate array (FPGA), a computer system, and a logic circuit configured to allow controller 100 to function in accordance with the present disclosure.

The operational parameters monitored by controller 100, in one embodiment, may include a pressure of fluid within first and/or second circuits 52, 54. For example, one or more pressure sensors 102-1 . . . 102-N (collectively referred to as pressure sensors 102) may be strategically located within first chamber and/or second chamber conduits 84, 86 to sense a pressure of the respective passages and generate a corresponding signal indicative of the pressure directed to controller 100. It is contemplated that any number of pressure sensors 102 may be placed in any location within first and/or second circuits 52, 54, as desired. It is further contemplated that other operational parameters such as, for example, speeds, temperatures, viscosities, densities, etc. may also or alternatively be monitored and used to regulate operation of hydraulic control system 50, if desired.

Hydraulic control system 50 may be fitted with an energy recovery arrangement that is in communication with at least first circuit 52 and configured to selectively extract and recover energy from waste fluid that is discharged from swing motor 49. Energy recovery arrangement (ERA) may include, among other things, a recovery valve block (RVB) 106 that is fluidly connectable between pump 58 and swing motor 49, a first accumulator 108 configured to selectively communicate with swing motor 49 via RVB 106, and a second accumulator 110 also configured to selectively and directly communicate with swing motor 49. In the disclosed embodiment, RVB 106 may be fixedly and mechanically connectable to one or both of swing control valve 56 and swing motor 49. RVB 106 may include an internal first passage 112 fluidly connectable to first chamber conduit 84, and an internal second passage 114 fluidly connectable to second chamber conduit 86. First accumulator 108 may be fluidly connected to RVB 106 via a conduit 116, while second accumulator 110 may be fluidly connectable to low-pressure passage 78 and drain passage 88, in parallel with tank 60, via a conduit 118.

RVB 106 may house a discharge valve 122 associated with first accumulator 108, and a charge valve 124 also associated with first accumulator 108 and disposed in parallel with discharge valve 122. Discharge and charge valves 122, 124 may be selectively movable in response to commands from controller 100 to fluidly communicate first accumulator 108 to the respective chambers of the swing motor for fluid discharging and charging purposes.

Discharge valve 122 may be a solenoid-operated or electrically operated, variable position, 3-way valve that is movable in response to a command from controller 100 to allow fluid from first accumulator 108 to enter swing motor 49 via one of the passages 112 and 114, based on a rotational direction of swing motor 49. In particular, discharge valve 122 may include a valve element 134 that is movable between a first position, a second position and a third position in response to command signals obtained from controller 100. Valve element 134 at the first position (shown in FIG. 2) inhibits flow of fluid between first accumulator 108 and swing motor 49. For assisting acceleration of swing motor 49, in a rotational direction as depicted in FIG. 2, valve element 134 is at the second position (not shown) and fluidly connects first accumulator 108 to first chamber of swing motor 49 to allow discharge of fluid from first accumulator 108 to swing motor 49 via passage 112. At such an instance, communication between first accumulator 108 and second chamber of swing motor 49 is blocked. Further, valve element 134 at the third position (not shown) fluidly connects first accumulator 108 to passage 114 to supply fluid from first accumulator 108 to second chamber of swing motor 49, for assisting acceleration of swing motor 49 in a rotational direction opposite to that shown in FIG. 2. At such an instance, communication between first accumulator 108 and first chamber of swing motor 49 is blocked. Valve element 134 may be spring-biased toward the first position and movable in response to a command from controller 100 to any position between the first, second, and third positions to thereby vary a flow rate of fluid from first accumulator 108 into one of the passages 112 or 114. When valve element 134 is at the second position or at the third position and a fluid pressure within first accumulator 108 exceeds a fluid pressure within one of the passages 112 or 114, fluid from first accumulator 108 may flow into one of the passages 112 or 114. Discharge valve 122 will be actuated when it is determined that swing motor 49 needs to accelerate either by difference in desired and measured speed of swing motor 49, measured differential pressure across swing motor 49, desired swing direction of swing motor 49, changes in desired speed of swing motor 49 or a combination of any of these. If it is determined that swing motor 49 should accelerate and first accumulator 108 has sufficient pressure to accelerate swing motor 49 (i.e. pressure of first accumulator 108 is greater than inlet port pressure swing motor 49), the desired position of valve element 134 is determined by the desired swing direction. A check valve 140 may be disposed between first accumulator 108 and discharge valve 122 to provide for a unidirectional flow of fluid from accumulator 108 into one of the passages 112 or 114 via discharge valve 122. Check valve 140 would prevent first accumulator 108 from charging by diverting pump flow from swing motor 49 in the event that pressure of first accumulator 108 is less than the inlet port pressure of swing motor 49.

The configuration of charge valve 124 may be substantially identical to discharge valve 122, and movable in response to a command signals from controller 100 to allow flow of fluid discharged from swing motor 49, during braking or deceleration of swing motor 49, to first accumulator 108 (i.e., to charge first accumulator 108). In particular, charge valve 124 may include a valve element 138 that is movable between a first position, a second position and a third position in response to command signals obtained from controller 100. When valve element 138 is at the first position (shown in FIG. 2), first accumulator 108 is disconnected from swing motor 49 such that fluid flow between swing motor 49 and first accumulator 108 is inhibited. When swing motor 49 rotates in a direction opposite to that shown in FIG. 2, valve element 138 is at the second position (not shown) and fluidly connects passage 112 to first accumulator 108, such that fluid is supplied from the first chamber of swing motor 49 to first accumulator 108. At such an instance, communication between accumulator 108 and second chamber of swing motor 49 is blocked. For swing motor rotating in rotational direction as depicted in FIG. 2, valve element 138 may be positioned at the third position (not shown) at which passage 114 is fluidly connected to first accumulator 108, such that fluid from the second chamber of swing motor 49 charges first accumulator via passage 114. At such an instance, communication between accumulator 108 and first chamber of swing motor 49 is blocked. Valve element 138 may be spring-biased toward the first position and movable in response to a command from controller 100 to any position between the first, second, and third positions to thereby vary a flow rate of fluid from one of the passages 112 or 114 into first accumulator 108. When valve element 138 is moved away from the first position (i.e., in the second position, or in the third position or in an intermediate position between the first, second, and third positions) and a fluid pressure within one of the passages 112 or 114 exceeds a fluid pressure within first accumulator 108, fluid from one of the passage 112 or 114 may fill (i.e., charge) first accumulator 108. Charge valve 124 will be actuated when it is determined that swing motor 49 needs to decelerate either by difference in desired and measured speed of swing motor 49, measured differential pressure across swing motor 49, desired swing direction of swing motor 49, changes in desired speed commands or a combination of any of these. If it is determined that the swing motor 49 should decelerate and appropriate of the first and second chambers of swing motor 49 has sufficient pressure to charge first accumulator 108 (i.e. outlet port pressure of swing motor 49 is greater than pressure of first accumulator 108), the desired position of valve element 138 is determined by the desired swing direction. A check valve 136 may be disposed between charge valve 124 and first accumulator 108 to provide for a unidirectional flow of fluid into accumulator 108 via charge valve 124. Check valve 136 would prevent first accumulator 108 from discharging fluid to tank 60 through valve elements 94 or 98 in the event that pressure of first accumulator 108 is greater than the outlet port pressure of swing motor 49.

An additional pressure sensor 102-1 may be associated with first accumulator 108 and configured to generate signals indicative of a pressure of fluid within first accumulator 108, if desired. In the disclosed embodiment, the additional pressure sensor 102-1 may be disposed between first accumulator 108 and discharge valve 122. It is contemplated, however, that the additional pressure sensor 102-1 may alternatively be disposed between first accumulator 108 and charge valve 124 or directly connected to first accumulator 108, if desired. Signals from the additional pressure sensor 102-1 may be directed to controller 100 for use in regulating operation of discharge and/or charge valves 122, 124.

First and second accumulators 108, 110 may each embody pressure vessels filled with a compressible gas that are configured to store pressurized fluid for future use by swing motor 49. The compressible gas may include, for example, nitrogen, argon, helium, or another appropriate compressible gas. As fluid in communication with first and second accumulators 108, 110 exceeds predetermined pressures of first and second accumulators 108, 110, the fluid may flow into accumulators 108, 110. Because the gas therein is compressible, it may act like a spring and compress as the fluid flows into first and second accumulators 108, 110. When the pressure of the fluid within conduits 116, 118 drops below the predetermined pressures of first and second accumulators 108, 110, the compressed gas may expand and urge the fluid from within first and second accumulators 108, 110 to exit. It is contemplated that first and second accumulators 108, 110 may alternatively embody membrane/spring-biased or bladder types of accumulators, if desired.

In the disclosed embodiment, first accumulator 108 may be a larger (i.e., about 5-20 times larger) and higher-pressure (i.e., about 5-60 times higher-pressure) accumulator, as compared to second accumulator 110. Specifically, first accumulator 108 may be configured to accumulate up to about 50-100 L of fluid having a pressure in the range of about 260-300 bar, while second accumulator 110 may be configured to accumulate up to about 10 L of fluid having a pressure in the range of about 5-30 bar. In this configuration, first accumulator 108 may be used primarily to assist the motion of swing motor 49 and to improve machine efficiencies, while second accumulator may be used primarily as a makeup accumulator to help reduce a likelihood of voiding at swing motor 49. It is contemplated, however, that other volumes and pressures may be accommodated by first and/or second accumulators 108, 110, if desired.

Controller 100 may be configured to selectively cause first accumulator 108 to charge and discharge, thereby improving performance of machine 10. In particular, a typical swinging motion of implement system 14 instituted by swing motor 49 may consist of segments of time during which swing motor 49 is accelerating a swinging movement of implement system 14, and segments of time during which swing motor 49 is decelerating the swinging movement of implement system 14. The acceleration segments may require significant energy from swing motor 49 that is conventionally realized by way of pressurized fluid supplied to swing motor 49 by pump 58, while the deceleration segments may produce significant energy in the form of pressurized fluid that is conventionally wasted through discharge to tank 60. Both the acceleration and the deceleration segments may require swing motor 49 to convert significant amounts of hydraulic energy to swing kinetic energy, and vice versa. The pressurized fluid passing through swing motor 49 during deceleration, however, still contains a large amount of energy. If the fluid passing through swing motor 49 is selectively collected within first accumulator 108 during the deceleration segments, this energy can then be returned to (i.e., discharged) and reused by swing motor 49 during the ensuing acceleration segments. Swing motor 49 can be assisted during the acceleration segments by selectively causing first accumulator 108 to discharge pressurized fluid into the appropriate chamber of swing motor 49 (via discharge valve 122, one of the passages 112 or 114, and the appropriate one of first and second chamber conduits 84, 86), alone or together with high-pressure fluid from pump 58, thereby propelling swing motor 49 at the same or greater rate with less pump power than otherwise possible via pump 58 alone. Swing motor 49 can be assisted during the deceleration segments by selectively causing first accumulator 108 to charge with fluid exiting swing motor 49, thereby providing additional resistance to the motion of swing motor 49 and lowering a restriction and cooling requirement of the fluid exiting swing motor 49.

In an alternative embodiment, controller 100 may be configured to selectively control charging of first accumulator 108 with fluid exiting pump 58, as opposed to fluid exiting swing motor 49. That is, during a peak-shaving or economy mode of operation, controller 100 may be configured to cause accumulator 108 to charge with fluid exiting pump 58 (e.g., via control valve 56, the appropriate one of first and second chamber conduits 84, 86, one of the passages 112 or 114, and charge valve 124) when pump 58 has excess capacity (i.e., a capacity greater than required by circuits 54, 56 to move work tool 16 as requested by the operator). Then, during times when pump 58 has insufficient capacity to adequately power swing motor 49, the high-pressure fluid previously collected from pump 58 within first accumulator 108 may be discharged in the manner described above to assist swing motor 49.

Controller 100 may be configured to regulate the charging and discharging of first accumulator 108 based on a current or ongoing segment of the excavation, material handling, or other work cycle of machine 10. In particular, based on input received from one or more performance sensors 141, controller 100 may be configured to partition a typical work cycle performed by machine 10 into a plurality of segments, for example, into a dig segment, a swing-to-dump acceleration segment, a swing-to-dump deceleration segment, a dump segment, a swing-to-dig acceleration segment, and a swing-to-dig deceleration segment, as will be described in more detail below. Based on the segment of the excavation work cycle currently being performed, controller 100 may selectively cause first accumulator 108 to charge or discharge, thereby assisting swing motor 49 during the acceleration and deceleration segments.

One or more maps and/or dynamic elements relating signals from sensor(s) 141 to the different segments of the excavation work cycle may be stored within the memory of controller 100. Each of these maps may include a collection of data in the form of tables, graphs, and/or equations. The dynamic elements may include integrators, filters, rate limiters, and delay elements. In one example, threshold speeds, cylinder pressures, and/or operator input (i.e., lever position) associated with the start and/or end of one or more of the segments may be stored within the maps. In another example, threshold forces and/or actuator positions associated with the start and/or end of one or more of the segments may be stored within the maps. Controller 100 may be configured to reference the signals from sensor(s) 141 with the maps and filters stored in memory to determine the segment of the excavation work cycle currently being executed, and then regulate the charging and discharging of first accumulator 108 accordingly. Controller 100 may allow the operator of machine 10 to directly modify these maps and/or to select specific maps from available relationship maps stored in the memory of controller 100 to affect segment partitioning and accumulator control, as desired. It is contemplated that the maps may additionally or alternatively be automatically selectable based on modes of machine operation, if desired.

Sensor(s) 141 may be associated with the generally horizontal swinging motion of work tool 16 imparted by swing motor 49 (i.e., the motion of frame 42 relative to undercarriage member 44). For example, sensor 141 may embody a rotational position or speed sensor associated with the operation of swing motor 49, an angular position or speed sensor associated with the pivot connection between frame 42 and undercarriage member 44, a local or global coordinate position or speed sensor associated with any linkage member connecting work tool 16 to undercarriage member 44 or with work tool 16 itself, a displacement sensor associated with movement of operator input device 48, or any other type of sensor known in the art that may generate a signal indicative of a swing position, speed, force, or other swing-related parameter of machine 10. The signal generated by sensor(s) 141 may be sent to and recorded by controller 100 during each excavation work cycle. It is contemplated that controller 100 may derive a swing speed based on a position signal from sensor 141 and an elapsed period of time, if desired.

Alternatively or additionally, sensor(s) 141 may be associated with the vertical pivoting motion of work tool 16 imparted by hydraulic cylinders 28 (i.e., associated with the lifting and lowering motions of boom 24 relative to frame 42). Specifically, sensor 141 may be an angular position or speed sensor associated with a pivot joint between boom 24 and frame 42, a displacement sensor associated with hydraulic cylinders 28, a local or global coordinate position or speed sensor associated with any linkage member connecting work tool 16 to frame 42 or with work tool 16 itself, a displacement sensor associated with movement of operator input device 48, or any other type of sensor known in the art that may generate a signal indicative of a pivoting position or speed of boom 24. It is contemplated that controller 100 may derive a pivot speed based on a position signal from sensor 141 and an elapsed period of time, if desired.

In yet an additional embodiment, sensor(s) 141 may be associated with the tilting force of work tool 16 imparted by hydraulic cylinder 38. Specifically, sensor 141 may be a pressure sensor associated with one or more chambers within hydraulic cylinder 38 or any other type of sensor known in the art that may generate a signal indicative of a tilting force of machine 10 generated during a dig and dump operation of work tool 16.

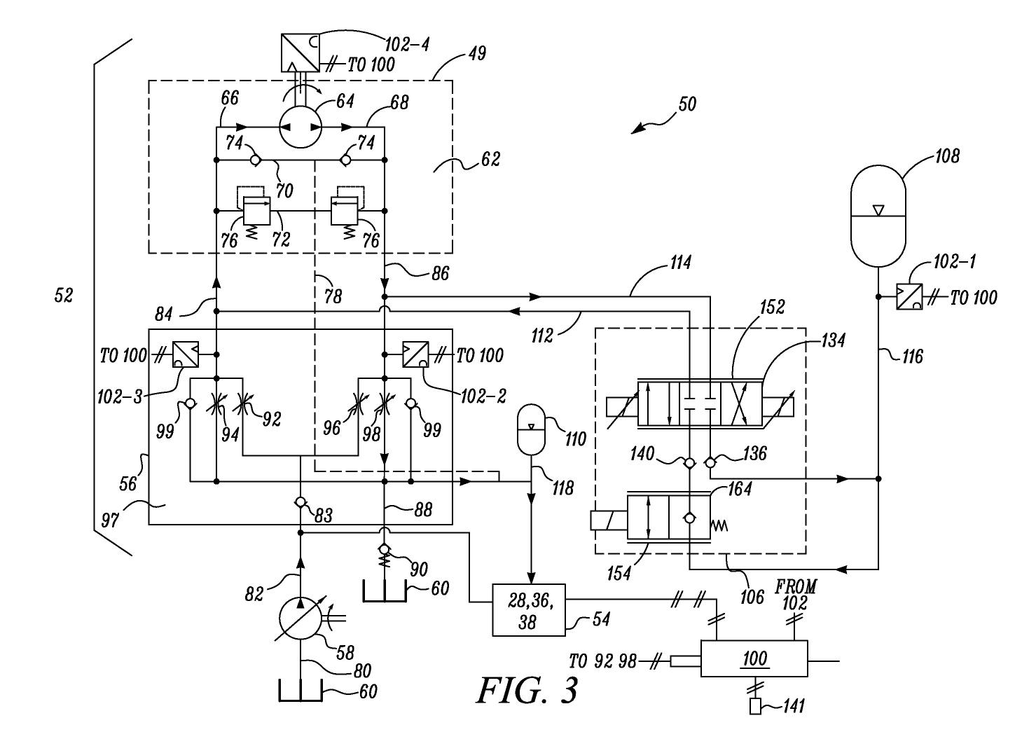

FIG. 3 illustrates an alternate configuration of hydraulic control system 50. In the disclosed embodiment, RVB 106 may house a charge-discharge valve 152 associated with first accumulator 108, and a discharge valve 154 also associated with charge-discharge valve 152. Charge-discharge valve 152 is connected between first accumulator 108 and first and second chambers of swing motor 49. Discharge valve 154 is connected between first accumulator 108 and charge-discharge valve 152. Charge-discharge valve 152 and discharge valve 154 may be selectively movable in response to commands from controller 100 to fluidly communicate first accumulator 108 with swing motor 49 for fluid discharging and charging purposes.

Charge-discharge valve 152 may be a directional, 4-way, 3-position, electrically or solenoid controlled, spool valve. Examples of charge-discharge valve 152 may include, without limitation, piston type valve, ball valve, rotary spool or sliding spool valve, and the like. Discharge valve 154 may be a directional, 2-way, 2-position, electrically or solenoid controlled, spool valve. In particular, charge-discharge valve 152 may have a valve element 162 movable between one or more positions in response to command signals from controller 100, for charging and/or discharging of first accumulator 108. Similarly, discharge valve 154 may also have a valve element 164 movable between one or more positions in response to command signals from controller 100, for assisting discharging of first accumulator 108.

Referring back to FIG. 3, valve element 162 is at the first position, where fluid flow between swing motor and first accumulator 108 is inhibited. At such an instance, valve element 164 is also at the first position such that fluid discharged from first accumulator 108 to swing motor 49 is inhibited. For a rotational direction of swing motor 49 in either direction, and during charging operation, valve element 162 is moved away from its first position to the second or third position (not shown) such that first accumulator 108 is connected to the respective second or first chamber of swing motor 49 for selective charging of first accumulator 108 from fluid exiting swing motor 49 via one of passages 112, 114 from fluid discharged by the respective chamber of swing motor 49, during braking or deceleration of swing motor 49. In this scenario, valve element 164 can remain at its first position, as shown in the figure.

For a rotational direction of swing motor 49 in either direction, and during discharging operation, valve element 162 is moved away from its first position to the second or third position (not shown). In such a scenario, valve element 164 is moved to its second position (not shown). To this end, first accumulator 108 is fluidly connected to the respective chambers of swing motor 49 to selectively discharge fluid to swing motor 49 for assisting acceleration of swing motor 49 via the respective passage 112 or 114. Furthermore during discharging operation, when valve element 162 is at either the second or third position and valve element 164 is at its second position, communication between swing motor 49 and first accumulator 108 can be maintained for charging. In one example, during transitioning between discharging and charging modes, pressurized fluid from swing motor can even bypass the accumulator and be redirected through discharge valve 154 to improve system hydraulic balance and reduce pressure spikes. A check valve 136 may be disposed between charge-discharge valve 152 and first accumulator 108 to provide for a unidirectional flow of fluid from swing motor 49 to accumulator 108 via charge-discharge valve 152. Similarly, a check valve 140 may be disposed between discharge valve 154 and swing motor 49 to provide for a unidirectional flow of fluid from accumulator 108 to swing motor 49 via discharge valve 154.

In an embodiment, when fluid from swing motor 49 charges first accumulator 108, discharge valve 154 may be positioned at the first position (shown in FIG. 3) irrespective of position of charge-discharge valve 152. Such an arrangement may ensure that fluid is not discharged from first accumulator 108 during charging of first accumulator 108.

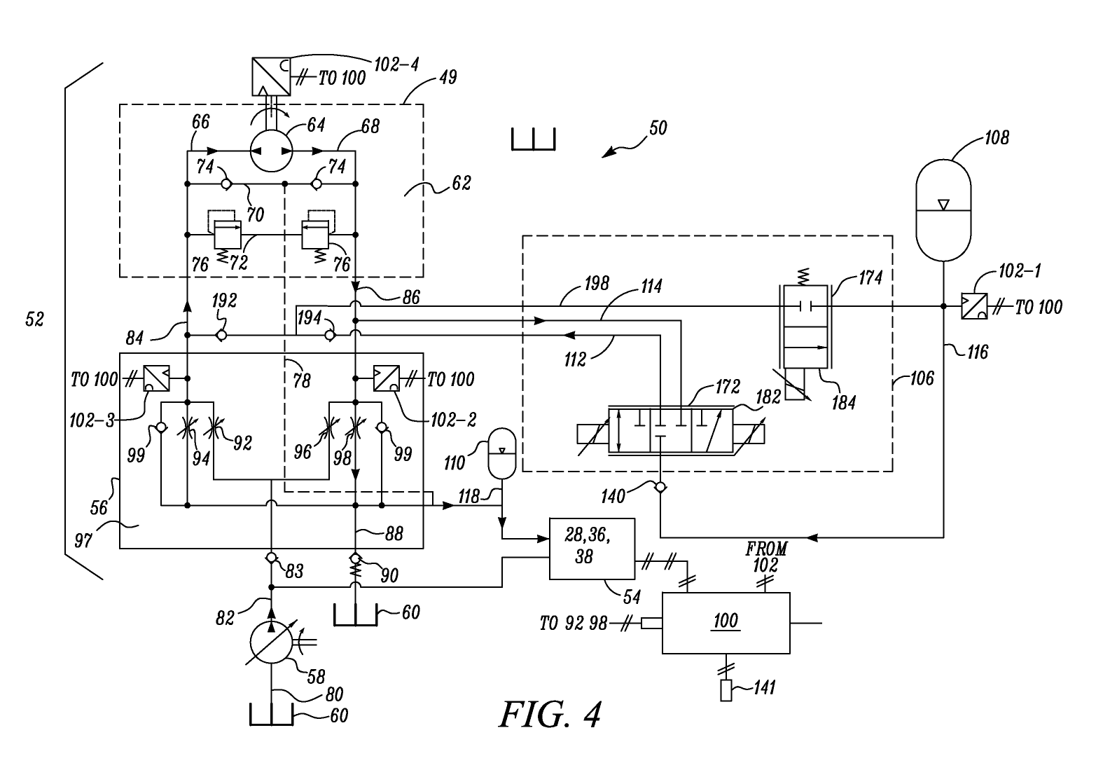

FIG. 4 illustrates another alternate configuration of hydraulic control system 50. In the disclosed embodiment, a first check valve 192 and a second check valve 194 is included in first circuit 52. First check valve 192 is connected between first chamber of swing motor 49 and first accumulator 108. Second check valve 194 is connected between second chamber of swing motor 49 and first accumulator 108. Further, RVB 106 includes a discharge valve 172 and a charge valve 174. Discharge valve 172 is connected between first and second chambers of swing motor 49 and first accumulator 108. Charge valve 174 is connected between first accumulator 108 and swing motor 49 via first and second check valves 192, 194. Discharge valve 172 and charge valve 174 may be selectively movable in response to commands from controller 100 to fluidly communicate first accumulator 108 with swing motor 49 for fluid discharging and charging purposes.

In particular, the configuration of discharge valve 172 may be substantially identical to valves 122 or 124, that is a solenoid-operated or electrically operated, variable position, 3-way valve, and movable in response to a command signals from controller 100 to allow flow of fluid discharged from swing motor 49, during braking or deceleration of swing motor 49. Valve 172 may have a valve element 182 movable between one or more positions in response to command signals from controller 100, for discharging of first accumulator 108. Similarly, charge valve 174, shown as a solenoid-operated or electrically operated, variable position, 2-way valve, may also have a valve element 184 movable between one or more positions in response to command signals from controller 100, for assisting charging of first accumulator 108.

As depicted in FIG. 4, valve element 182 at the first position disconnects first accumulator 108 from swing motor 49, such that flow between first accumulator 108 and swing motor 49 is inhibited. For rotational direction of swing motor 49 in either direction, and during discharging mode, valve element 182 is at the second or third position (not shown) such that first accumulator 108 is fluidly connected to first or second chamber of swing motor 49 to discharge fluid from first accumulator 108 into swing motor 49 via the respective passages 112 or 114. At such an instance, the other of the first or second chamber of swing motor 49 is blocked. Further, valve element 184 is at the first position (shown in FIG. 4) to disconnect swing motor 49 and first accumulator 108 such that flow of fluid between swing motor 49 and first accumulator 108 is inhibited. A check valve 140 may be disposed between discharge valve 172 and first accumulator 108 to provide for a unidirectional flow of fluid from accumulator 108 to swing motor 49 via discharge valve 172.

Valve element 184, at the first position (shown in FIG. 4) disconnects swing motor 49 and first accumulator 108 such that flow of fluid between swing motor 49 and first accumulator 108 is inhibited. At the second position, valve element 184 connects the higher pressure side of first and second check valves 192, 194 to first accumulator 108 for selective charging of first accumulator 108 via passage 198. Such an arrangement can ensure that fluid flow between swing motor 49 and first accumulator 108 is based upon pressure of first and second chambers of swing motor 49 and not on pressures of passages 112, 114. Thus, speed discontinuities in swing motor 49 may be avoided and efficient working of swing motor 49 may be obtained.

As described above, second accumulator 110 may discharge fluid any time a pressure within low-pressure passage 78 falls below the pressure of fluid within second accumulator 110. Accordingly, the discharge of fluid from second accumulator 110 into first circuit 52 may not be directly regulated via controller 100. However, because second accumulator 110 may charge with fluid from first circuit 52 whenever the pressure within drain passage 88 exceeds the pressure of fluid within second accumulator 110, and because control valve 56 may affect the pressure within drain passage 88, controller 100 may have some control over the charging of second accumulator 110 with fluid from first circuit 52 via control valve 56.

In some situations, it may be possible for both first and second accumulators 108, 110 to simultaneously charge with pressurized fluid. In particular, it may be possible for second accumulator 110 to simultaneously charge with pressurized fluid when pump 58 is providing pressurized fluid to both swing motor 49 and to first accumulator 108. At these times, the fluid exiting pump 58 may be directed into first accumulator 108, while the fluid exiting swing motor 49 may be directed into second accumulator 110.

Second accumulator 110 may also be charged via second circuit 54, if desired. In particular, any time waste fluid from second circuit 54 (i.e., fluid draining from second circuit 54 to tank 60) has a pressure greater than the threshold pressure of second accumulator 110, the waste fluid may be collected within second accumulator 110. In a similar manner, pressurized fluid within second accumulator 110 may be selectively discharged into second circuit 54 when the pressure within second circuit 54 falls below the pressure of fluid collected within second accumulator 110.

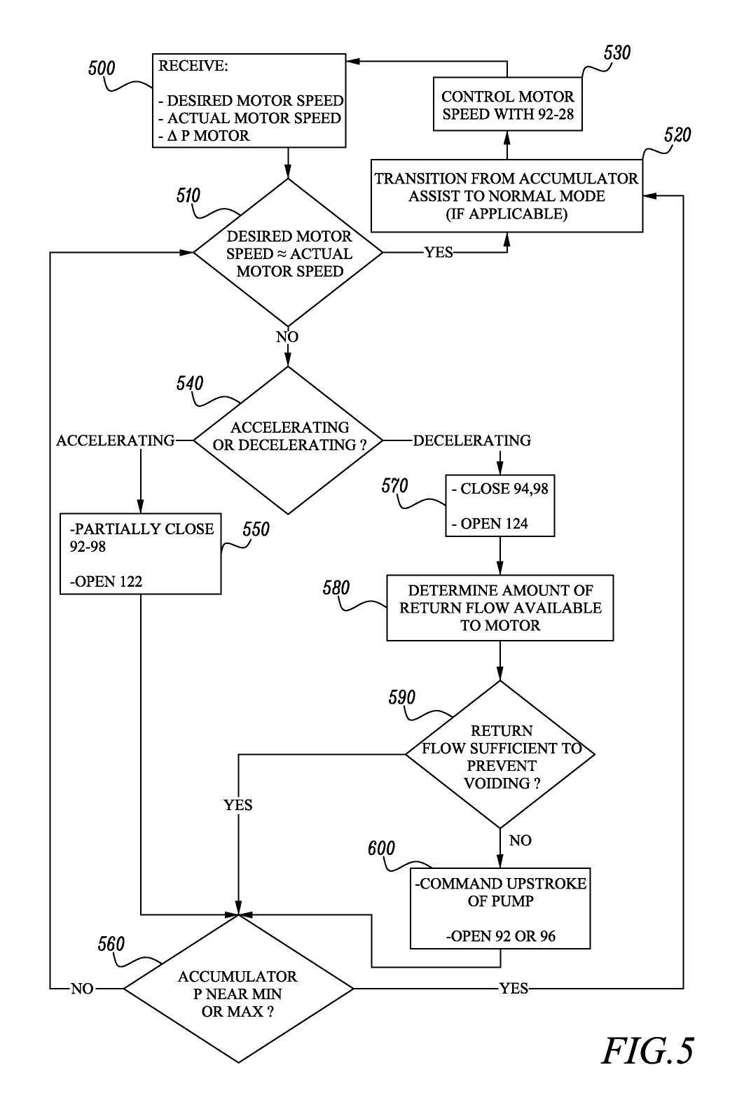

During charging and discharging of first accumulator 108, care should be taken to facilitate smooth transitions between pump-assisted swinging and accumulator-assisted swinging of work tool 14. FIG. 5 illustrates an exemplary method used by controller 100 for this purpose. FIG. 5 will be discussed in more detail below to further illustrate the disclosed concepts.

### INDUSTRIAL APPLICABILITY

The disclosed hydraulic control system may be applicable to any excavation machine that performs a substantially repetitive work cycle, which involves swinging movements of a work tool. The disclosed hydraulic control system may help to improve machine performance and efficiency by assisting swinging acceleration and deceleration of the work tool with an accumulator during different segments of the work cycle. The unique method used by the disclosed hydraulic control system may help ensure smooth transition between pump-assisted activities and accumulator-assisted activities. Further, the disclosed hydraulic system may be useful to mitigate speed discontinuities and faulty operation of an excavation machine by using electrically operated spool valves for charging and discharging purposes of an accumulator. Operation of the disclosed hydraulic control system will now be described in detail with reference to FIG. 5.

As seen in the flowchart of FIG. 5, controller 100 may receive input indicative of a desired speed of swing motor 49, an actual speed of swing motor 49, and a pressure gradient across swing motor 49 (Step 500). The input indicative of the desired speed may be a signal generated by operator input device 48, while the input indicative of actual speed may be a signal generated by performance sensor 141 associated with swing motor 49. The input indicative of the pressure gradient across swing motor 49 may include signals generated by pressure sensors 102 associated with each chamber of the swing motor. It is contemplated that other input indicative of the desired speed, actual speed, and/or pressure gradient of swing motor 49 may also or alternatively be utilized, if desired.

Controller 100 may then determine if the desired speed is about equal to (i.e., within a threshold amount of) the actual speed (Step 510). In the disclosed embodiment, the pressure gradient across swing motor 49 may be directly related to a difference between the desired and actual speeds of swing motor 49. In particular, when the pressure gradient is large, swing motor 49 may either be undergoing a significant acceleration or a significant deceleration (depending on whether the pressure gradient is increasing or decreasing), which corresponds with a significant difference between the desired and actual speeds of swing motor 49. In contrast, when the pressure gradient is less than a threshold amount, swing motor 49 may not be significantly accelerating or decelerating and the difference between the desired and actual speeds is accordingly small. Alternatively, the signals from sensors 102 and 141 may be utilized to determine the difference between the desired and actual speeds.

When the difference between the desired speed and the actual speed is small (e.g., equal to or less than a low threshold amount), controller 100 may conclude that use of first accumulator 108 is unwarranted (i.e., that charging or discharging of first accumulator 108 would either not be possible or would be inefficient) and follow the normal mode of swing operation using pump pressure to move work tool 14 (Step 520). In the normal mode of operation, controller 100 may utilize the corresponding drain and supply elements 92-98 in a conventional manner to regulate flows of fluid from pump 58 to swing motor 49 and from swing motor 49 to tank 60 (Step 530). If already using accumulator 108 to move work tool 14, controller 100 may transition to the normal mode of operation in step 520.

When the difference between the desired speed and the actual speed is large (e.g., more than the low threshold amount), controller 100 may determine whether swing motor 49 is accelerating or decelerating (Step 540). Controller 100 may determine whether swing motor 49 is accelerating or decelerating based on the pressure gradient across swing motor 49, the desired speed of swing motor 49, and the actual speed of swing motor 49. For example, when the desired speed is in the same direction as and larger than the actual speed and the pressure gradient across swing motor 49 is substantially large (e.g. greater than 50 bar), controller 100 may conclude that swing motor 49 is accelerating. In contrast, when the desired speed is in the same direction as and less than the actual speed (or in a direction opposing the actual speed), and the pressure gradient is large, controller 100 may conclude that swing motor 49 is decelerating.

When controller 100 determines that swing motor 49 is accelerating, controller 100 may utilize pressurized fluid stored within first accumulator 108 to assist the movement of work tool 14. In particular, controller 100 may at least partially close the appropriate one of first and second chamber supply elements 92, 96 (depending on the desired rotational direction of swing motor 49) to inhibit fluid flow from pump 58 to swing motor 49. Simultaneously, controller 100 may at least partially open discharge valve 122 (second or third position) to supply fluid from first accumulator 108 to swing motor 49 (Step 550). It should be noted that the closing of first or second chamber supply elements 92, 96 may be coordinated with the opening of discharge valve 122, such that a gradual reduction in flow provided by pump 58 may be accommodated by a corresponding gradual increase in flow provided by first accumulator 108. In this manner, the motion of swing motor 49 may be continuous and substantially unaffected by the switch between supply sources.

While supplying fluid from first accumulator 108 to swing motor 49, controller 100 may monitor the pressure of fluid within first accumulator 108 and compare the monitored pressure to a one or more pressure thresholds (e.g., to a minimum pressure threshold during acceleration) (Step 560). If the pressure of fluid within first accumulator 108 decreases below the appropriate pressure threshold (e.g., when the pressure of the fluid within first accumulator 108 reaches or falls below the minimum pressure threshold during acceleration), control may return to step 510 where operation will transition to the normal mode. In this situation, the capacity of first accumulator 108 to provide fluid will has been partially or completely exhausted, and pump 58 should be used to continue the swinging motion of work tool 14. Otherwise, control may loop back to step 510.

If at step 540, controller 100 instead determines that swing motor 49 is decelerating, controller 100 may use first accumulator 108 to slow work tool 14 and to simultaneously capture otherwise wasted energy in the form of stored pressurized fluid. In particular, controller 100 may at least partially close the appropriate one of first and second chamber drain elements 94, 98 (depending on the desired rotational direction of swing motor 49) to inhibit fluid flow from swing motor 49 being directed back to pump 58 and/or into tank 60, and simultaneously open charge valve 124 (second or third position) to instead direct the pressurized fluid from swing motor 49 into first accumulator 108 for storage (Step 570). As the fluid enters first accumulator 108, the pressure within first accumulator 108 and in the passages leading back to swing motor 49 may increase, thereby providing greater resistance to the rotation of swing motor 49 and slowing swing motor 49. It should be noted that the gradual closing of first or second chamber drain elements 94, 98 may be coordinated with the gradual opening of charge valves, such that the reduction in flow to tank 60 may be accommodated by the increase in flow into first accumulator 108. In this manner, the motion of swing motor 49 may be continuous and substantially unaffected by the change in collection reservoirs.

During deceleration, because substantially all of the return flow of fluid from swing motor 49 may be directed into first accumulator 108, as opposed to being routed back to low-pressure passage 78 (through relief valves 76) and/or drain passage 88 (through first or second drain valves 84, 98) from where the flow could reach the opposite side of swing motor 49 (through check and/or makeup valves 74, 99), while the displacement of pump 58 may naturally de-stroke since flow is not requested from first and/or second circuits 52, 54. In this situation, it may be possible for swing motor 49 to be starved of makeup fluid and, if not accounted for, swing motor 49 could be caused to cavitate during charging of first accumulator 108. Accordingly, controller 100 may be configured to determine an amount of return flow available to swing motor 49 during a deceleration event (Step 580). In particular, controller 100 may monitor the activities of other actuators of machine 10 (e.g., the activities of actuators in second circuit 54) and/or monitor the flow rate of fluid returning from second circuit 54 back into first circuit 52. Controller 100 may then compare the flow rate of return fluid from second circuit 54 to an amount of makeup fluid required by swing motor 49 to prevent voiding (Step 590). When the amount of return fluid from second circuit 54 is insufficient to prevent cavitation of swing motor 49, controller 100 may command pump 58 to increase its displacement (i.e., to upstroke) and command the appropriate one of first or second chamber supply elements 92, 96 to open and provide additional makeup fluid to swing motor 49 (Step 600). Control may pass from steps 590 and 600 to step 560.

While directing fluid into first accumulator 108 from swing motor 49 during deceleration, controller 100 may monitor the pressure of fluid within first accumulator 108 and compare the monitored pressure to a one or more pressure thresholds (e.g., to a maximum pressure threshold during deceleration) (Step 560). If the pressure of fluid within first accumulator 108 increases beyond the appropriate pressure threshold (e.g., when the pressure of the fluid within first accumulator 108 reaches or exceeds the maximum pressure threshold during deceleration), control may return to step 520 where operation will transition to the normal mode. In this situation, the capacity of first accumulator 108 to receive fluid will have been nearly or completely exhausted, and pump 58 and/or tank 60 should be used to consume the return fluid and continue the swinging motion of work tool 14. Otherwise, control may loop back to step 510.

Several benefits may be associated with the disclosed hydraulic control system. First, because hydraulic control system 50 may utilize a high-pressure accumulator and a low-pressure accumulator (i.e., first and second accumulators 108, 110), fluid discharged from swing motor 49 during acceleration segments of the excavation work cycle may be recovered within second accumulator 110. This double recovery of energy may help to increase the efficiency of machine 10. Next, the use of second accumulator 110 may help to reduce the likelihood of voiding at swing motor 49. The ability to adjust accumulator charging and discharging based on a current segment of the excavation work cycle and/or based on a current mode of operation, may allow hydraulic control system 50 to tailor swing performance of machine 10 for particular applications, thereby enhancing machine performance and/or further improving machine efficiency. Further, the use of hydro-mechanically operated valves to connect the respective high pressure side of the swing motor 49 to the energy recovery circuit can be removed, thus saving implementation costs. Finally, use of the disclosed method implemented by controller 100 during energy recovery, may result in smooth or even seamless transition between pump-assisted and accumulator-assisted operations.

It will be apparent to those skilled in the art that various modifications and variations can be made to the disclosed hydraulic control system. Other embodiments will be apparent to those skilled in the art from consideration of the specification and practice of the disclosed hydraulic control system. It is intended that the specification and examples be considered as exemplary only, with a true scope being indicated by the following claims and their equivalents.

1. A hydraulic system, comprising:
a tank;
a pump configured to draw fluid from the tank and pressurize the fluid;
a swing motor, having a first chamber and a second chamber, wherein the swing motor is driven by a flow of pressurized fluid from the pump;
port pressure sensors associated with each of the first and second chamber of the swing motor;
an accumulator configured to selectively receive pressurized fluid discharged from the swing motor and selectively supply pressurized fluid to the swing motor;
an accumulator pressure sensor associated with the accumulator;
a first valve coupled between the accumulator and the first and second chambers of the swing motor, and a second valve coupled between the accumulator and the first and second chambers of the swing motor; and
wherein at least one of the first and second valves is a three-way valve movable between a first position, a second position, and a third position, at the first position flow of the fluid between the swing motor and the accumulator is inhibited, at the second position one of the first and second chambers of the swing motor is fluidly coupled to the accumulator and the other of the first and second chambers of the swing motor is blocked from fluid communication with the accumulator, at the third position the other of the first and second chambers of the swing motor is fluidly coupled to the accumulator and the one of the first and second chambers of the swing motor is blocked from fluid communication with the accumulator; and
a controller in electrical communication with the first valve and the second valve and the port and accumulator pressure sensors; the controller configured to command movement of at least one of the first valve and the second valve based on the pressure of the chambers and the accumulator.

2. The hydraulic system of claim 1, wherein the controller is further configured to:
receive input indicative of a difference between a desired speed and an actual speed of the swing motor;
determine if the swing motor is accelerating or decelerating based on the difference between the desired and actual speeds; and
cause the accumulator to selectively charge or discharge only when the swing motor is accelerating or decelerating.

3. The hydraulic system of claim 1, wherein the input indicative of the difference between the desired speed and the actual speed includes a first signal corresponding to a displacement position of an operator input device and a second signal generated by a speed sensor.

4. The hydraulic system of claim 1, further including a sensor configured to detect a rotational direction of the swing motor, wherein the controller is configured to determine that the swing motor is accelerating or decelerating based on the pressure differential and the rotational direction of the swing motor.

5. The hydraulic system of claim 1, wherein the controller is further configured to:
determine an amount of return fluid from another actuator that is available as makeup fluid for the swing motor; and
selective cause the pump to increase its displacement based on the amount of return fluid.

6. The hydraulic system of claim 1, wherein the first valve is the three-way valve.

7. The hydraulic system of claim 6, wherein the second valve is the three-way valve.

8. The hydraulic system of claim 1, wherein the second valve is the three-way valve.

9. The hydraulic system of claim 8, wherein the first valve is a two-way valve, movable between a first position and a second position, at the first position flow of the fluid between the swing motor and the accumulator is inhibited, and at the second position one of the first and second chambers of the swing motor is fluidly coupled to the accumulator.

10. The hydraulic system of claim 9, wherein a first check valve is disposed between the first chamber and the first valve, and a second check valve is disposed between the second chamber and the first valve, and a single passage leads between the first valve and the first and second check valves.

11. A hydraulic system, comprising:
a tank;
a pump configured to draw fluid from the tank and pressurize the fluid;
a swing motor, having a first chamber and a second chamber, wherein the swing motor is driven by a flow of pressurized fluid from the pump;
a means for sensing pressure of each of the first and second chambers of the swing motor;
an accumulator configured to selectively receive pressurized fluid discharged from the swing motor and selectively supply pressurized fluid to the swing motor;
a means for sensing an accumulator pressure;
a first valve coupled between the accumulator and the first and second chambers of the swing motor, and a second valve coupled between the accumulator and the first valve; and
wherein at least one of the first and second valves is a three-way valve movable between a first position, a second position, and a third position, at the first position flow of the fluid between the swing motor and the accumulator is inhibited, at the second position one of the first and second chambers of the swing motor is fluidly coupled to the accumulator and the other of the first and second chambers of the swing motor is fluidly coupled to the second valve, at the third position the other of the first and second chambers of the swing motor is fluidly coupled to the accumulator and the one of the first and second chambers of the swing motor is fluidly coupled to the second valve; and
a controller in electrical communication with the first valve and the second valve and the means for sensing pressure of the chambers and the means for sensing accumulator pressure; the controller configured to command movement of at least one of the first valve and the second valve based on the pressure of the chambers and the accumulator.

12. The hydraulic system of claim 11, wherein the first valve and the second valves are the three-way valves.

13. The hydraulic system of claim 11, wherein the second valve is the three-way valve, and the first valve is a two-way valve, movable between a first position and a second position, at the first position flow of the fluid between the swing motor and the accumulator is inhibited, and at the second position one of the first and second chambers of the swing motor is fluidly coupled to the accumulator.

14. The hydraulic system of claim 11, further comprising:
at least one control valve configured to control fluid flow between the pump, the swing motor, and the tank; and
at least one accumulator valve configured to regulate fluid flow into and out of the accumulator.

15. The hydraulic system of claim 11, wherein:
the at least one control valve includes at least one supply element and at least one drain element; and
the controller is configured to:
close the at least one supply element and open the at least one accumulator valve when the swing motor is accelerating; and
close the at least one drain element and open the at least one accumulator valve when the swing motor is decelerating.

16. A hydraulic system, comprising:
a tank;
a pump configured to draw fluid from the tank and pressurize the fluid;
a swing motor, having a first chamber and a second chamber, wherein the swing motor is driven by a flow of pressurized fluid from the pump;
port pressure sensors associated with each of the first and second chambers of the swing motor;
an accumulator configured to selectively receive pressurized fluid discharged from the swing motor and selectively supply pressurized fluid to the swing motor;
an accumulator pressure sensor associated with the accumulator;
a first check valve coupled between the accumulator and the first chamber of the swing motor, and a second check valve coupled between the accumulator and the second chamber of the swing motor;
a first valve coupled between the accumulator and the first and second chambers of the swing motor, and a second valve coupled between the accumulator and the first and second check valves; and
wherein the first valve is a three-way valve movable between a first position, a second position, and a third position, at the first position flow of the fluid between the swing motor and the accumulator is inhibited, at the second position one of the first and second chambers of the swing motor is fluidly coupled to the accumulator and the other of the first and second chambers of the swing motor is blocked from fluid communication with the accumulator, at the third position the other of the first and second chambers of the swing motor is fluidly coupled to the accumulator and the one of the first and second chambers of the swing motor is blocked from fluid communication with the accumulator;
wherein the second valve is a two-way valve movable between a first position and a second position, at the first position flow of the fluid between the swing motor and the accumulator is inhibited, at the second position a higher pressure one of the first and second chambers of the swing motor is fluidly coupled to the accumulator; and
a controller in electrical communication with the first valve and the second valve and the port and accumulator pressure sensors; the controller configured to command movement of at least one of the first valve and the second valve based on the pressure of the chambers and the accumulator.

17. The hydraulic system of claim 16, wherein the first valve is a two-way valve, movable between a first position and a second position, at the first position flow of the fluid between the swing motor and the accumulator is inhibited, and at the second position one of the first and second chambers of the swing motor is fluidly coupled to the accumulator.

18. The hydraulic system of claim 16, wherein a first check valve is disposed between the first chamber and the first valve, and a second check valve is disposed between the second chamber and the first valve, and a single passage leads between the first valve and the first and second check valves.

19. The hydraulic system of claim 16, further comprising:
at least one control valve configured to control fluid flow between the pump, the swing motor, and the tank; and at least one accumulator valve configured to regulate fluid flow into and out of the accumulator.
